(19) United States
(12) Patent Application Publication
(10) Pub. No.: US 2012/0255511 A1
(43) Pub. Date: Oct. 11, 2012

(54) Natural Gas-Steam Powered Automotive Vehicle

(76) Inventor: Kevin Sebastian Henwood, San Francisco, CA (US)

(21) Appl. No.: 13/081,755

(22) Filed: Apr. 7, 2011

(51) Int. Cl. F02B 43/00

(52) U.S. Cl. 123/1 A

(57) ABSTRACT

The conventional automobile is powered solely by an internal combustion engine. Recent automobiles have been produced which are powered by natural gas. This improvement aims to add an external-combustion steam engine to the mix. The envisioned automobile can be thought of as a natural gas-steam powered hybrid automobile. By utilizing steam power, the fuel efficiency of the current state of automotive technology can be significantly augmented.

### CROSS-REFERENCES TO RELATED APPLICATION

n/a

### STATEMENT REGARDING FEDERALLY SPONSORED RESEARCH AND DEVELOPMENT

n/a

### THE NAMES OF THE PARTIES TO A JOINT RESEARCH AGREEMENT

n/a

### INCORPORATION-BY-REFERENCE OF MATERIAL SUBMITTED ON A COMPACT DISC

n/a

### BACKGROUND OF THE INVENTION

1. Field of the Invention

The present invention is in the field of vehicular power plants and more specifically in the field of automobiles. It is a type of automotive quite similar to that currently manufactured by American automotive manufacturing infrastructure. However, it has the potential for significantly increased fuel efficiency, reduced emissions, and perhaps most importantly, is very easily manufactured within the current scope of the American automotive manufacturing industry. It accomplishes this by pairing an internal combustion engine with a steam engine.

2. The Prior Art

The current automobile produced in America today is powered by an internal combustion engine. Many such average size automobiles seem to be able to only realize a fuel efficiency of roughly 30 miles per gallon of gasoline. There are attempts to manufacture alternative fuel vehicles capable of realizing greater fuel efficiency. Most promising among these is the gas-electric hybrid as exemplified by the Toyota Prius. These vehicles can achieve higher fuel efficiency. However, the main drawback right now is the prohibitive cost of the battery packs necessary to drive their electric motors. There are also fuel-cell vehicles being developed as well as electric vehicles. However, these too have significant logistical problems that must be overcome. Electric vehicles must be charged for long periods of time and driven only for somewhat short distances. Fuel cell vehicles pose a somewhat greater hazard due to the inherent properties of hydrogen fuel.

The present invention circumvents the challenges presented by the prior paths pursued. It accomplishes this by pairing a standard internal combustion engine to a conventional, piston-type steam engine. By so doing, fuel efficiency can be theoretically doubled, emissions halved, manufacture costs only marginally increased, and the current American automotive infrastructure reinvigorated with an automotive which can quickly and easily be introduced to the public.

In U.S. Pat. No 5,385,211 issued Jan. 31, 1995 to Carroll there is a vehicle powered by an electric drivetrain with steam and internal combustion engines recharging the battery packs. The present invention improves upon the prior art by eliminating the need for expensive battery packs. It requires the current setup of the internal combustion engine automobile paired with a steam engine under the hood. The electric component of the invention is that already present in the current art. The present invention incorporates a conventional steam engine a primary producer of motive force.

### BRIEF SUMMARY OF THE INVENTION

The present invention provides an automobile powered by both an internal combustion engine and a piston-type steam engine paired to the driveshaft, with a boiler to generate the needed steam. Upon starting, the internal combustion engine powers the vehicle like the present art. However, after a few minutes of driving, the required steam pressure is reached in the boiler apparatus to operate the piston-type steam engine and provide additional motive force. By doing so, less fuel is consumed and fuel efficiency is increased.

### BRIEF DESCRIPTION OF THE DRAWING

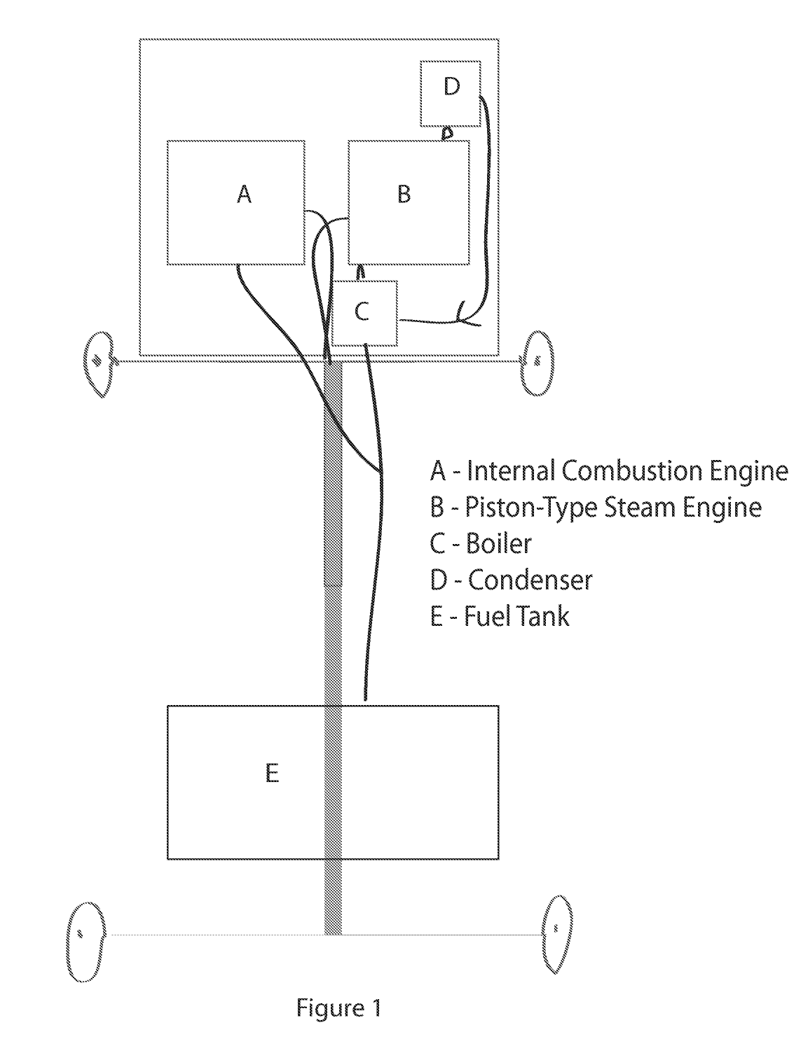

One preferred embodiment is shown in the drawing, FIG. 1. The drawing shows a skeletal outline of the automobile. It contains an internal combustion engine as shown by ‘A’. It also contains an old-fashioned, conventional, piston-type steam engine as shown by ‘B’. There is a boiler as shown by ‘C’. The boiler and internal combustion engine are powered by fuel from the fuel tank labeled as ‘E’. There is also a condenser labeled as ‘D’.

### DETAILED DESCRIPTION OF THE INVENTION

Much like the current mass-produced automobile, the preferred embodiment of the natural gas-steam powered hybrid automobile contains an internal combustion engine. This engine gets natural gas from the fuel tank. In the preferred embodiment of this automobile, there is also a conventional steam engine paired to the drivetrain. The conventional, piston-type steam engine is powered by steam generated by a boiler. The boiler is powered by natural gas. Spent steam from the steam engine goes through a condenser and is recycled back into the boiler. Upon starting the vehicle, the necessary steam pressure is not yet attained, so the automotive operates entirely from power delivered to the drivetrain from the standard internal combustion engine. However, after a few minutes, the boiler has produced steam of adequate pressure and the steam engine kicks in to help power the vehicle. In the preferred embodiment, fuel efficiency can be theoretically doubled relative to that of the current internal combustion automobile.

1. A more fuel-efficient automotive vehicle comprising:
(a) an internal combustion engine powered by natural gas
(b) paired with a piston-type steam engine also powered by natural gas
(c) with both said piston-type steam engine and said internal combustion engine connected to the drivetrain
(d) a natural gas-powered boiler to produce necessary steam
(e) and a condenser to recycle the spent steam from the piston-type steam engine.
